(19) United States
(12) Patent Application Publication
(10) Pub. No.: US 2024/0285115 A1
(43) Pub. Date: Aug. 29, 2024

(54) Kava Batch Beverage Brewing Method and Apparatus

(71) Applicant: Matthew Masifilo, Sarasota, FL (US)

(72) Inventor: Matthew Masifilo, Sarasota, FL (US)

(21) Appl. No.: 18/371,277

(22) Filed: Sep. 21, 2023

Related U.S. Application Data
(60) Provisional application No. 63/447,862, filed on Feb. 23, 2023.

(51) Int. Cl. A47J 31/20; A23F 3/18; A23F 3/34; A47J 31/06; A47J 31/44; A47J 31/52; A47J 43/046; A47J 43/07; A47J 43/08; B01D 29/27

(52) U.S. Cl. CPC A47J 31/20; A23F 3/18; A23F 3/34; A47J 31/0636; A47J 31/4407; A47J 31/52; A47J 43/046; A47J 43/0722; A47J 43/085; B01D 29/27

(57) ABSTRACT

An apparatus and method for brewing batches of kava beverage. Using the apparatus and method, batches of kava beverage are brewed in a mixing vessel with a motorized internal agitator and a filter lid that lid fits atop the mixing vessel and a mesh filter bag that hangs into the mixing vessel. The filter bag is filled with kava root and the vessel is filled with a beverage medium. The motorized agitator is activated and the agitation from the agitators simulates a traditional kava brewing process, creating a batch of kava beverage for serving.

### CROSS-REFERENCE TO RELATED APPLICATIONS

This application claims priority to provisional application U.S. Ser. No. 63/447,862 filed Feb. 23, 2023.

### BACKGROUND

The present invention relates to a beverage made from the roots of the Kava plant (Piper methysticum), often referred to as Kava.

Kava originated in the Pacific Ocean cultures of Melanesia and Polynesia. Kava is sedating and is primarily consumed to relax without disrupting mental clarity. It is commonly used by people to treat insomnia, social anxiety, and as an alcohol replacement.

The traditional method for brewing kava involves taking kava root (powdered, pressed, ground or shredded) and placing it into fine bags constructed of muslin, cheese cloths, and fine nylon. These materials are used for the bags because they have fine pores that entrain the kava root inside them. Traditional tea balls and tea bags are not sufficient because the kava root is finer than tea leaves used for brewing tea and will infiltrate into the kava beverage, and the tea bags will rip in the brewing process.

The filled bags are placed in the beverage medium of choice and allowed to seep for several minutes minimum. The beverage medium must be cool or lukewarm. Hot beverage must not be used because the high temperature destroys kava root's main active ingredients known as kavalactones. Hot beverage also causes the gelatinization of the starch present in ground kava root powder creating an unpleasant kava beverage.

Once you let your filled bags seep in the beverage medium, the bags are removed and kneaded or squeezed to remove all of the liquid from the bag typically into a large bowl. The kavalactones are not water soluble, so they need to be compressed in order to be extracted from the root and rubbed off the root through compression or agitation. The kneading/squeezing process will extract the kavalactones from the root into the liquid. The liquid collected in the bowl is the kava that will be consumed, and the bag and residual kava root is disposed of.

This method of brewing has numerous drawbacks. The first drawback of the brewing method is that the process is inefficient. In order to create a kava, the brewer will need prepare the kava in an intermediary larger bowl, and then transfer the extracted kava from the bowl into a cup where it will be ultimately consumed. Removal of the need for the intermediary bowl from the process would make for a more efficient brewing process.

A second drawback of the brewing method is that the process is messy. During the kneading or squeezing procedure, either the hands of the brewer will get coated in the kava, likely requiring the brewer to wash their hands after brewing, or the brewer will need to wear gloves that will be disposed of after brewing the kava. Creating a brewing process that would remove the need for the brewer to wring or squeeze the kava from the bags would be a cleaner process.

A third drawback for this brewing method is that it is not conducive to restaurant sales. Regardless of the cleanliness of the beverage prepares, there will always be a segment of the population who will be turned off from buying a beverage prepared by a food service employee who wrings their beverage out of a bag using their bare hands or even gloved hands. Creating a brewing process that would remove the need for the brewer to wring or squeeze the kava from the bags would likely make the prepared kava more conducive to restaurant sales.

Patent Application 2016/0309944 solved these issues by developing an apparatus and method for brewing kava beverage to brew kava beverage by filling a hollow two-piece spherical structure with extremely fine mesh screens with kava. The filled apparatus is placed in a shaker bottle filled with liquid and is shaken vigorously, extracting the kavalactones from the root into the liquid, creating the kava beverage. This method of brewing kava beverage is quicker and simpler than traditional methods of brewing kava beverage.

While the aforementioned prior art Patent Application 2016/0309944 resolved a number of issues related to brewing kava with its device and method, the device and method had a limitation of being limited to single or small servings of kava beverage. When operating a business where a significant amount of kava is made and served to guests or when an individual wants a large pot of kava, there is a need for an apparatus and method for brewing kava which accommodates brewing large batches of kava beverage quickly and efficiently, while continuing to resolve the aforementioned issues with traditional kava beverage brewing methods of inefficiency, messiness, and a non-sanitary brewing method.

### SUMMARY

The aim of the present invention is to provide a kava brewing method that is capable of producing kava beverage in large batches that allow for more efficiency when running a business or operation where large volumes of kava beverage will be served.

The kava brewing method of the current invention involves an agitation device that is comprised of a mixing vessel and a mixing base. The mixing vessel comprises a liquid vessel, a filter lid, an internal agitator, and a first coupler. The filter lid fits atop the liquid vessel and has a hole in the center of the lid, where a filter bag with an open top is fit into.

The mixing base comprises a mixing motor, mixer controls, and a second coupler that matches the first coupler.

The kava brewing method of the current invention further involves measuring and placing a quantity of kava root into the hole in the filter bag installed in the filter lid. The preferred kava root form being ground kava root powder, but potentially being other forms of kava root (powdered, pressed, ground or shredded) if desired by the user. A beverage medium is then poured into the mixing vessel also through hole in the filter bag installed the filter lid, wetting the kava root, and pushing the kava root to the bottom of the filter bag.

Once the mixing vessel has been placed on the mixing base and filled with the beverage medium and the kava root filter bag, the agitator is activated by the controls on the mixing base initiating the mixing motor and transferring rotation from the mixing motor to the agitator through the first and second couplers. The agitator will alternate spinning between clockwise and counterclockwise directions, twisting the kava root filled filter bag. As agitator spins in a single direction the and the kava root filled filter bag twists, exerting compressive forces on the kava root, which extract the kavalactones from the root. When the agitator changes direction the compressive stresses will be momentarily relieved as the filter bag unwinds, and beverage medium will flow through the filter bag mixing the extracted kavalactones into the beverage medium, until the filter bag again starts to twist, and repeating the process of extracting the kavalactones from the root through compressive stresses. Additionally, during the mixing process, when the spinning agitator contacts the filled mixing bag, it will pummel the kava from the bottom, exerting impact forces on the kava root, which also extracts the kavalactones from the root.

Once the mixing process is complete, and the kava beverage has reached sufficient potency, the mixing vessel can be removed from the mixing base, and several individual kava beverages can be served from a single batch.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

For a better understanding of the particular embodiments of the present invention reference may be made to the following drawings exemplary of the invention, in which:

FIG. 1 is a perspective view of the assembled agitation device;

FIG. 2 a perspective view of the assembled agitation device in operation;

FIG. 3 is an exploded perspective view of the assembled agitation device;

FIG. 4 is a front view of the assembled agitation device;

FIG. 5A is a perspective view of the filter lid;

FIG. 5B is a top view of the filter lid;

FIG. 5C is a front view of the filter lid;

FIG. 6A is a perspective view of the filter bag;

FIG. 6B is a top view of the filter bag;

FIG. 6C is a front view of the filter bag;

FIG. 7A is a perspective view of the mixing vessel;

FIG. 7B is a top view of the mixing vessel;

FIG. 7C is a front view of the mixing vessel;

FIG. 7D is a perspective view of the underside of mixing vessel;

FIG. 8A is a perspective view of the mixing base;

FIG. 8B is a top view of the mixing base;

FIG. 8C is a front view of the mixing base.

### DETAILED DESCRIPTION OF THE INVENTION AND PREFERRED EMBODIMENT

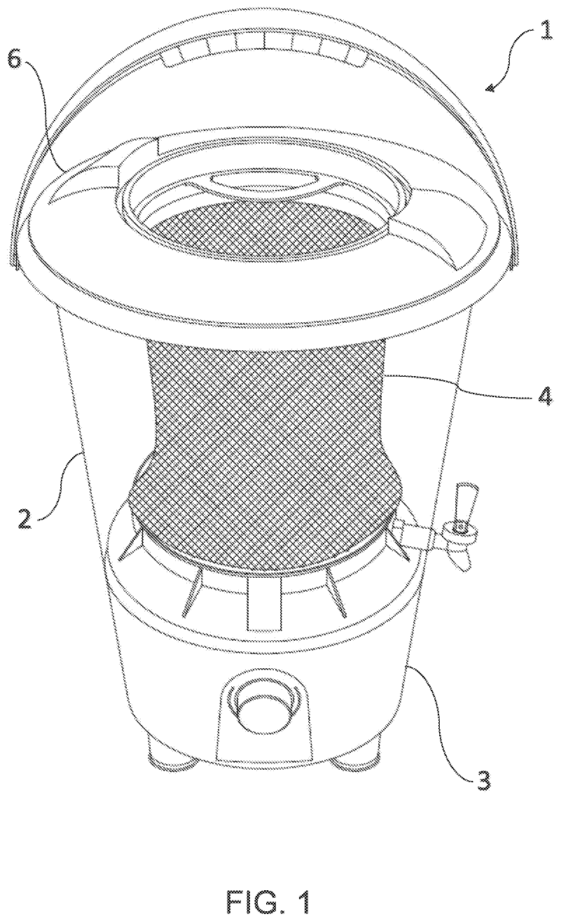

Referring to FIG. 1, the preferred embodiment for the agitation device 1 according to the present invention includes a mixing vessel 2, which sits atop the mixing base 3. The mixing base comprises a motorized drive that drives the agitation through a first and second coupler 12, 9, one located on the top of the mixing base 3 and the second located on the bottom of the mixing vessel 2.

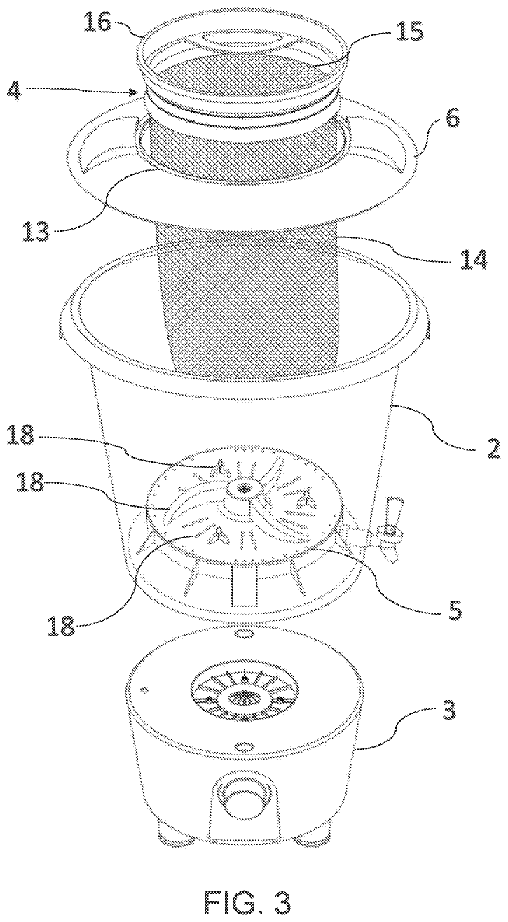

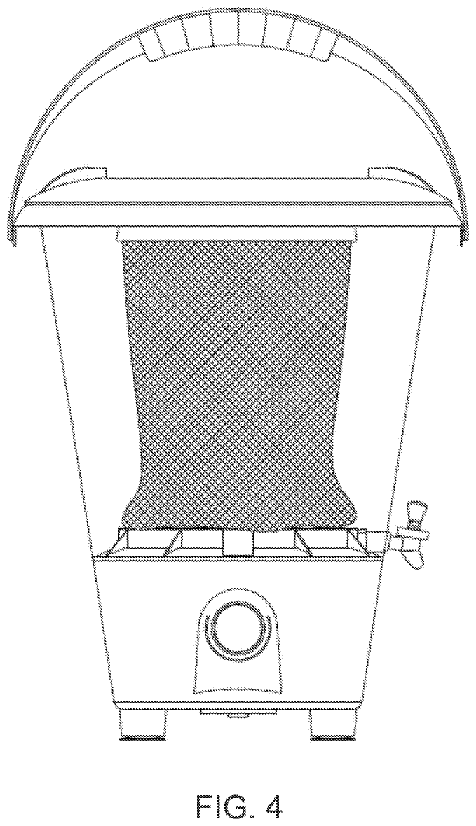

Referring to FIGS. 3 & 4, the agitation device 1 comprises a mixing vessel 2, a mixing base 3, a filter lid 6, and a filter bag 4.

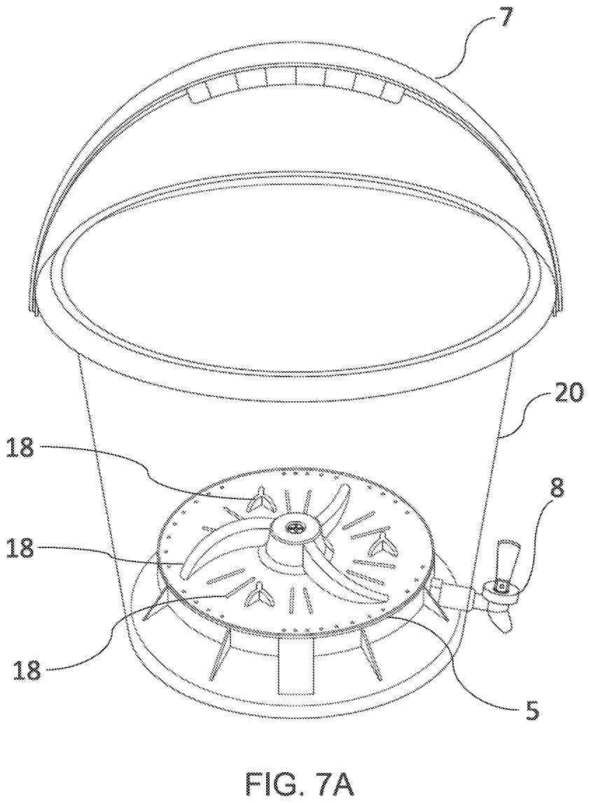

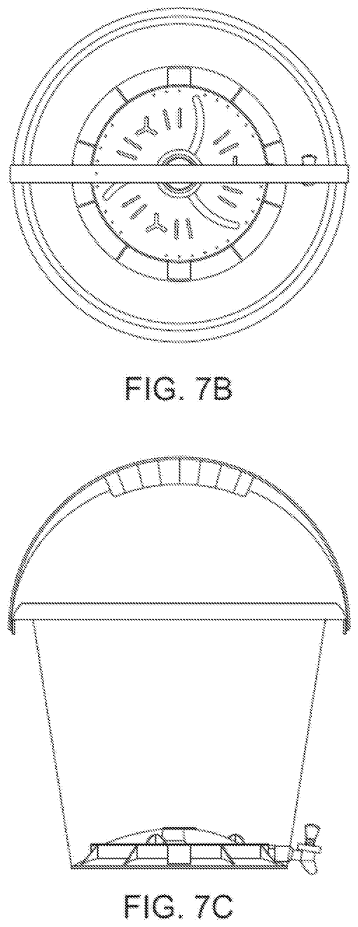

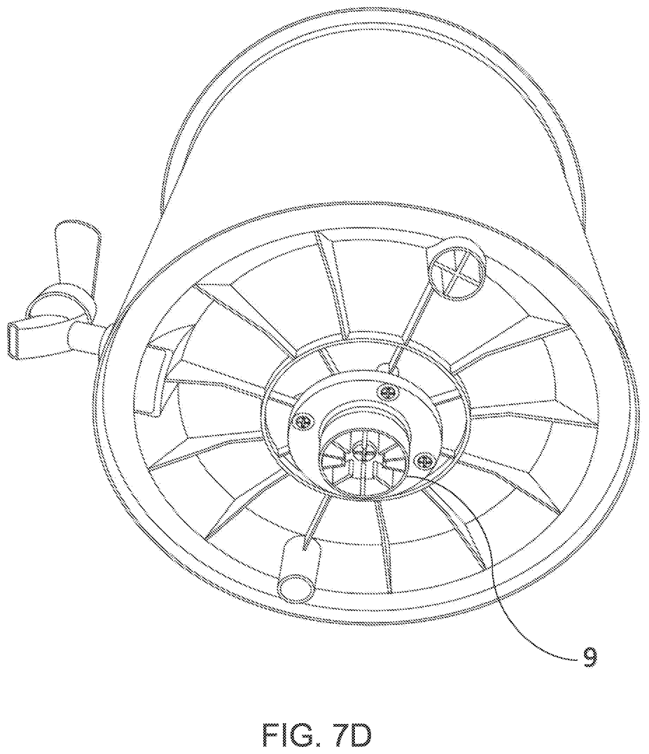

Referring to FIGS. 7A, 7B, 7C, and 7D the mixing vessel 2, comprises a vessel 20, a rotary agitator 5, a handle 7, a serving spout 8, and a second coupler 9. The second coupler 9 and the rotary agitator 5 are connected by a sealed drive shaft (not depicted), which transfers rotation from the coupler to the agitator, also preventing the beverage medium and kava beverage from leaking through the bottom of the vessel 20. The top surface of the rotary agitator 5 has various shaped rotary agitator ridges 18 that exert compressive and impact forces on any object that comes into contact with the rotary agitator ridges 18 when the rotary agitator 5 is rotating. The rotary agitator ridges 18 should not have sharp edges, so not to cut or tear the filter bag 4.

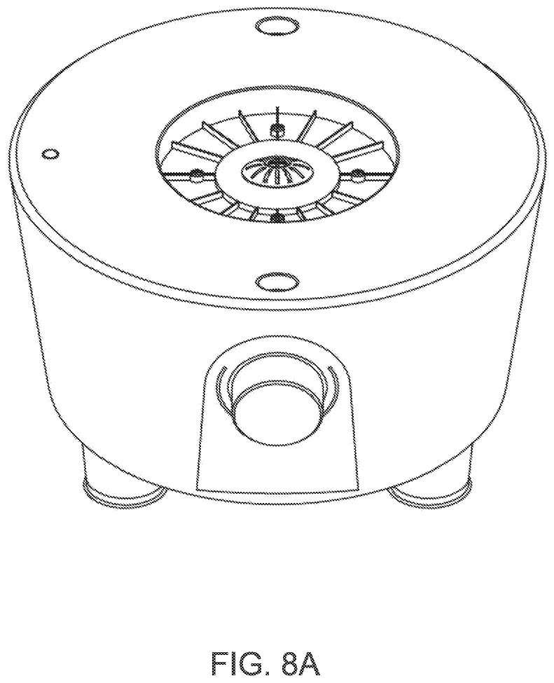

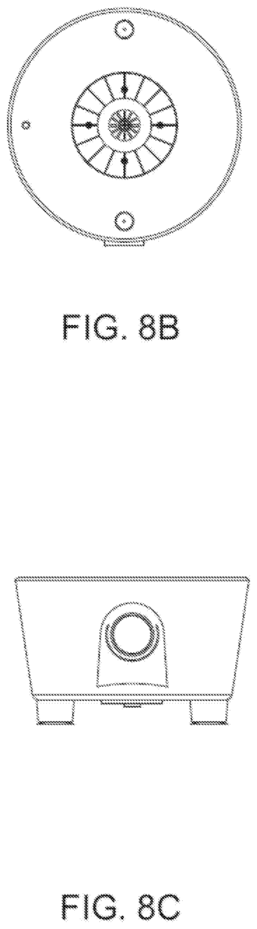

Referring to FIGS. 8A, 8B, and 8C, the mixing base 3, comprises a base structure 10, a motor (not depicted), a controller 11, and a first coupler 12. The motor is connected to the first coupler 12 by a drive shaft (not depicted), which transfers rotation from the motor to the first coupler 12. The controller 11 controls the run time and rotation direction of the motor, allowing the user to control the mixing cycle program the desired mixing cycle into the controller.

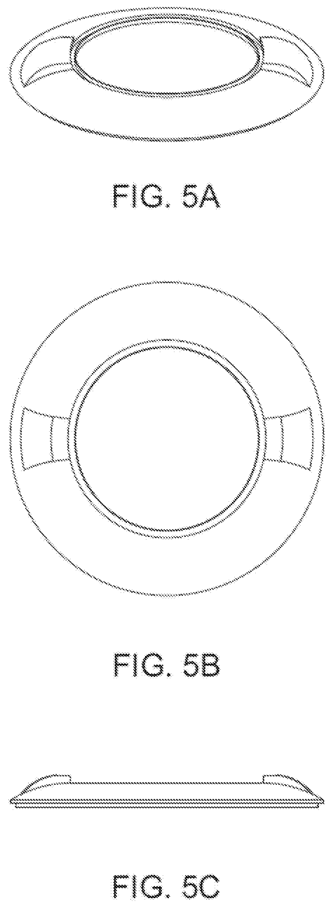

Referring to FIGS. 5A, 5B, and 5C, the filter lid 6 comprises a filter lid hole 13 where the filter bag 4 is installed.

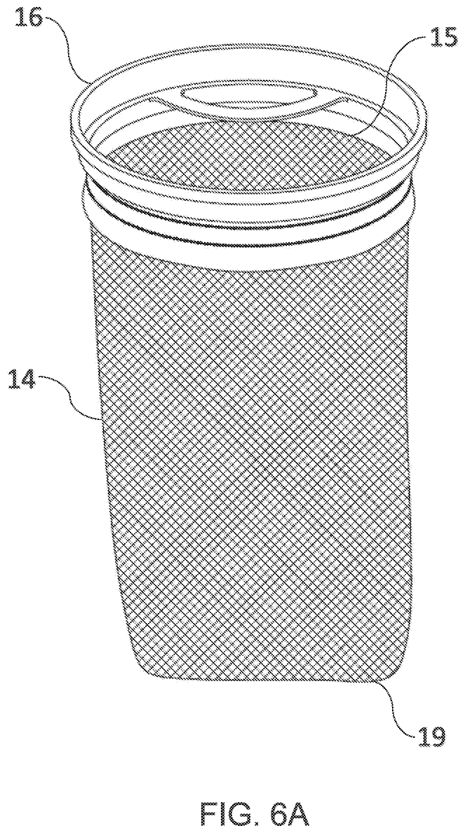

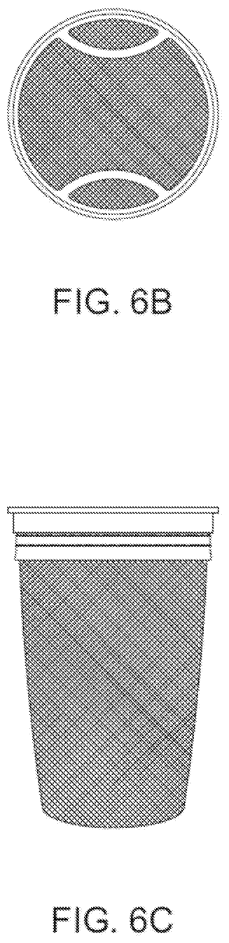

Referring to FIGS. 6A, 6B, and 6C, the filter bag 4 comprises a filter material 14 generally cylindrical in shape with an opening 15 at the top and is sealed on the bottom 19. In the preferred embodiment, the filter material 14 has micron rating of 75-200 microns, so that the openings in the filter material 14 are smaller than the ground kava particles. The filter bag opening 15 is connected to a filter bag/filter lid connector 16. The filter bag/filter lid connector 16 is constructed of a rigid material and is generally a hollow conical shape that on the bottom is slightly smaller than the filter lid hole 13 and on the top is slightly larger than the filter lid hole 13, so that the filter bag 4 will suspend from the filter lid 6. In the preferred embodiment, the filter material 14 is long enough that the filter bag 14 extends from the filter lid 6 to the rotary agitator 5. The filter material 14 is constructed of a flexible, not rigid, mesh material the allows for more surface area contact between the filter material 14 and the rotary agitator 5. Furthermore, the filter material 14 is a loose and fluid form structure which allows twisting and bending of the filter material 14 during agitation for better surface area of agitation on the kava root and prevents clumping vs a rigid structure.

Cool or lukewarm water is the preferred beverage medium 17 for extracting the kavalactones from the kava root powder, however, any number of beverage mediums could be used to extract the kavalactones. Water was chosen as the preferred beverage medium 17 due to its low-calorie count and it's readily availability. However, in the Pacific Ocean cultures of Polynesia, oftentimes milk, a solution of milk and water, or other fatty beverage mediums 17 are used in place of water. The fat in these beverage mediums 17 are capable of extracting the kavalactones from the kava root powder more efficiently than water alone. However, the resulting kava will have a greater calorie and fat content and therefore is not considered the preferred beverage medium 17 for the method.

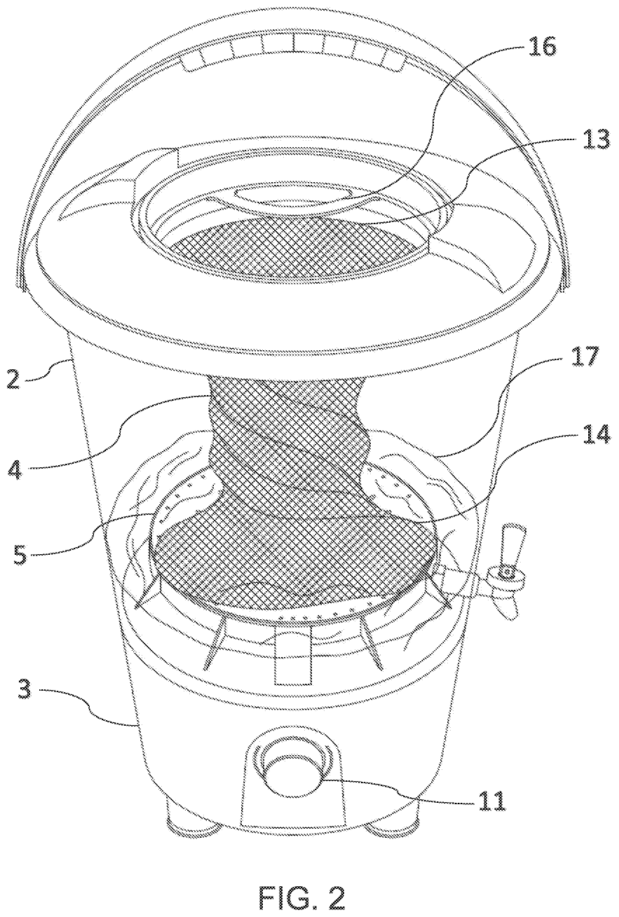

Referring to FIG. 2 the method of the present invention for brewing a kava beverage involves installing the filter bag 4 in the filter lid 6 and placing the filter lid 6 on the mixing vessel 2 and measuring the desired amount of kava root powder, ground to a particle size below 500 microns, and dispensing it into the filter bag 4 through the filter bag/filter lid connector 16. Then the beverage medium 17 is added to the mixing vessel 2 through the filter bag/filter lid connector 16, wetting the kava root powder. Wetting the kava root powder prevents the kava root powder from becoming airborne during the mixing process. A minimum of 50 grams of ground kava root powder per gallon of beverage medium 17, to brew a sufficiently potent kava beverage. The mixing vessel 2 is placed on the mixing base 3 so that the first coupler 12 and the second coupler 9 interlock.

The controller 11 is then set to the desired mixing cycle, and the agitation device 1. In operation, the rotary agitator 5 will spin in alternating clockwise and counterclockwise directions, as rotational speeds between 120 revolutions per minute (RPM) and 1000 RPM. The rotation of the rotary agitator 5 will cause the beverage medium 17 to impart rotational forces on the filled filter material 14, causing it to move at high speed in a circular motion around the mixing vessel 2. Additionally, referring to FIG. 2, the filled filter material 14 will twist constricting the filter material 14 around the kava root powder in the bottom of the filter material 14, exerting addition compressive forces against the kava root powder. Finally, since the filter material 14 is in contact with the rotary agitator 5 the rotary agitator ridges 18 will pummel the filter material 14, exerting periodic impact forces on the kava root powder as well. The forces the rotational, compressive and impact forces create a similar effect that the kneading and squeezing has in the traditional brewing method, extracting the kavalactones from the kava root powder into the beverage medium 17 creating a kava beverage.

When the rotary agitator 5 changes direction the compressive stresses will be momentarily relieved as the filter material 14 unwinds, and beverage medium 17 will flow through the filter material 14 mixing the extracted kavalactones into the beverage medium 17, until the filter material 14 again starts to twist, and repeating the process of extracting the kavalactones from the kava root powder through compressive stresses.

The controller 11 is incorporated into mixing base 3 and allows the user to program predetermined brewing cycles into the agitation device 1 which varies rotary agitator 5 rotation time, rotation speed, and rotation direction. Utilizing a programmed controller allows the user to multi-task, and brew multiple batches in multiple agitation devices 1. Alternatively, the controller 11 could also allow for user manual control of rotary agitator 5 rotation time, rotation speed, and rotation direction.

In the preferred embodiment of the invention the brewing method utilizes a mixing cycle where the controller 11 is pre-programmed for at least 5 minutes of alternating clockwise and counterclockwise rotation of the rotary agitator 5 in five to thirty second bursts.

Once the mixing cycle is complete, the mixing vessel 2 can be removed from the mixing base 3, by grasping the handle 7, and the brewed kava beverage in the mixing vessel 2 can be distributed into individual serving containers using the serving spout 8.

It would be appreciated by those skilled in the art that various changes and modifications can be made to the illustrated embodiments without departing from the spirit of the present invention. All such modifications and changes are intended to be covered by the appended claims.

What is claimed is:

1. A kava beverage brewing apparatus for brewing batches of kava beverage, said apparatus comprising:
a filter structure capable of containing a supply of kava root powder and comprising an open top, a closed bottom, and constructed of a flexible mesh material containing a plurality of perforations capable of confining kava root powder inside the filter structure;
a vessel, being hollow, and comprising an open top and a closed bottom with a mixer agitator located on an interior surface of the closed bottom of the vessel;
a means for suspending the filter structure inside of the vessel, oriented so that the open top of the filter structure is located inside the open top of the vessel and the closed bottom of the filter structure is in contact with the mixer agitator;
a means for rotating the mixer agitator.

2. The kava beverage brewing apparatus according to claim 1, wherein said means for suspending the filter structure inside of the vessel comprises a lid that rests upon the open top of the vessel with a hole in a center of the lid to which the open top of the filter can be affixed to.

3. The kava beverage brewing apparatus according to claim 1, wherein said a means for rotating the mixer agitator comprises a motor with a coupler that connects the motor to the to the mixer agitator.

4. The kava beverage brewing apparatus according to claim 3, further comprising a programmable controller that can be programmed with mixing cycles that causes the motor and coupler to rotate in clockwise and counterclockwise directions for a set rotational speed and a set time period.

5. The kava beverage brewing apparatus according to claim 1, wherein said mixer agitator further comprises ridges located on a top surface of the mixer agitator.

6. A method for brewing batches of kava beverage, said method comprising the steps of:
providing a filter structure capable of containing a supply of kava root powder and comprising an open top, a closed bottom, and constructed of a flexible mesh material containing a plurality of perforations capable of confining kava root powder inside the filter structure;
adding the kava root powder into the filter structure;
providing a vessel, being hollow, and comprising an open top and a closed bottom with a mixer agitator located on an interior surface of the closed bottom of the vessel;
adding a beverage medium into the vessel;
providing a means for suspending the filter structure inside of the vessel, oriented so that the open top of the filter structure is located inside the open top of the vessel and the closed bottom of the filter structure is in contact with the mixer agitator;
providing a means for rotating the mixer agitator;
rotating said agitator to causing the filter structure to twist between the open top and closed bottom constricting the flexible mesh material around the kava root powder, exerting addition compressive forces against the kava root powder, and additionally causing the bottom of the filter structure it to move in a circular motion around the vessel, imparting rotational forces on the kava root powder extracting kavalactones from the kava root powder into the beverage medium.

7. The method for brewing batches of kava beverage according to claim 6, wherein said means for rotating the mixer agitator comprises a motor with a coupler that connects the motor to the to the mixer agitator.

8. The method for brewing batches of kava beverage according to claim 7, further comprising a motor controller that can be programmed with mixing cycles that causes the motor and coupler to rotate in clockwise and counterclockwise directions for a set rotational speed and a set time period.

9. The method for brewing batches of kava beverage according to claim 6, wherein said mixer agitator further comprises ridges located on a top surface of the mixer agitator.

10. The method for brewing batches of kava beverage according to claim 6, wherein said means for suspending the filter structure inside of the vessel comprises a lid that rests upon the open top of the vessel with a hole in a center of the lid to which the open top of the filter can be affixed to.
